(19) United States
(12) Patent Application Publication
(10) Pub. No.: US 2018/0023652 A1
(43) Pub. Date: Jan. 25, 2018

(54) END MEMBER ASSEMBLIES AS WELL AS GAS SPRING ASSEMBLIES AND SUSPENSION SYSTEMS INCLUDING SAME

(71) Applicant: FIRESTONE INDUSTRIAL PRODUCTS COMPANY, LLC, INDIANAPOLIS, IN (US)

(72) Inventors: Matthew F. Byron, Indianapolis, IN (US); David D. Jackson, JR., Noblesville, IN (US)

(21) Appl. No.: 15/551,722

(22) PCT Filed: Feb. 18, 2016
(86) PCT No.: PCT/US2016/018542

§ 371 Date: Aug. 17, 2017

Related U.S. Application Data
(60) Provisional application No. 62/117,517, filed on Feb. 18, 2015.

(51) Int. Cl. F16F 9/04; F16F 3/08; F16F 1/40

(52) U.S. Cl. CPC F16F 9/0454; F16F 1/40; F16F 9/0409; F16F 9/0418; F16F 3/08

(57) ABSTRACT

End member assemblies that are dimensioned for use in forming a gas spring assembly can include an end structure that is dimensioned for securement to a flexible spring member to at least partially form the gas spring assembly. The end member assemblies can also include a compliant support structure that is operatively connected to the end structure to support the end structure in spaced relation to an associated structural component. The compliant support structure can include a base compliant element assembled together with a plurality of upper compliant elements that are different from the base compliant element but substantially identical to one another. Gas spring assemblies and suspension systems are also included.

### BACKGROUND

The subject matter of the present disclosure broadly relates to the art of spring devices and, more particularly, to end member assemblies that include an end structure and a compliant support structure. The compliant support structure can include a base compliant element assembled together with a plurality of upper compliant elements that are different from the base compliant element but substantially identical to one another. Gas spring assemblies including such end member assemblies and suspension systems including one or more of such gas spring assemblies are also included.

The subject matter of the present disclosure is capable of broad application and use in connection with a variety of applications and/or environments. For example, the subject matter of the present disclosure could be used in connection with gas spring assemblies of non-wheeled vehicles, support structures, height adjusting systems and actuators associated with industrial machinery, components thereof and/or other such equipment. In some cases, the subject matter of the present disclosure may find particular application and use in conjunction with rail vehicles, and will be described herein with particular reference thereto. However, it is to be appreciated that the subject matter of the present disclosure is amenable to use in other applications and environments, and that the specific uses shown and described herein are merely exemplary. Accordingly, the subject matter of the present disclosure is not intended to be limited to use associated with gas spring assemblies of suspension systems for wheeled (e.g., rail) vehicles.

Suspension systems, such as may be used in connection with motorized vehicles and/or rolling-stock rail vehicles, for example, can include one or more spring elements for accommodating forces and loads associated with the operation and use of the corresponding apparatus (e.g., motorized vehicle, rail vehicle) to which the suspension system is operatively connected. In such applications, it is often considered desirable to utilize spring elements that operate at a lower spring rate, as a reduced spring rate can favorably influence certain performance characteristics of the apparatus. That is, it is well understood in the art that the use of a spring element having a higher spring rate (i.e. a stiffer spring) will transmit a greater magnitude of inputs (e.g., inputs due to variations in the rails of a track) to the sprung mass of the apparatus and that, in some applications, this could undesirably effect the sprung mass, such as, for example, by resulting in a rougher, less-comfortable ride of a vehicle. Whereas, the use of spring elements having lower spring rates (i.e., a softer or more-compliant spring) will transmit a lesser amount of the inputs to the sprung mass but can also, undesirably, permit increased deflection under load.

In some cases, the spring devices can take the form of gas spring assemblies that utilize pressurized gas as the working medium. Gas spring assemblies of various types, kinds and constructions are well known and commonly used. Typical gas spring assemblies can include a flexible wall that is secured between comparatively rigid end members and/or end member assemblies.

Generally, vehicle performance characteristics, such as ride quality and comfort, are commonly identified as being related to factors, such as spring rate, that are acting in an approximately axial direction in relation to the gas spring assemblies. It has been recognized that deflection in the lateral direction (i.e., a direction transverse to the longitudinal axis of the gas spring assemblies) of the gas spring assemblies can also influence such vehicle performance characteristics. Furthermore, the design and construction of gas spring assemblies to provide certain performance characteristics in an underinflated and/or uninflated condition of use have also been developed. One challenge of known gas spring assemblies is balancing or otherwise obtaining desired performance characteristics under this combination of and/or other conditions of use.

Notwithstanding the broad usage and overall success of the wide variety of gas spring assemblies that include end member assemblies with compliant support structures that are known in the art, it is believed that a need exists to confront one or more of these competing goals and/or to overcome other disadvantages of known constructions while still retaining comparable or improved performance, ease of manufacture, ease of assembly, ease of installation and/or reduced cost of manufacture. Thus, it is believed to be generally desirable to develop new constructions and/or designs that may advance the art of spring devices.

### BRIEF SUMMARY

One example of an end member assembly in accordance with the subject matter of the present disclosure can have a longitudinal axis and can be dimensioned for securement to an associated flexible spring member to at least partially form an associated gas spring assembly. The end member assembly can include a compliant support structure and an end structure that is operatively attached to the compliant support structure. The compliant support structure can include a compliant mount assembly and a base member that is operatively connected to the compliant mount assembly. The base member can include a first surface dimensioned for abutting engagement with an associated structure component and a second surface facing opposite the first surface. The second surface can be approximately planar and can extend transverse to the longitudinal axis. The compliant mount assembly can include one or more rigid elements and one or more compliant elements that are permanently attached to one another such that a substantially fluid-tight connection is formed therebetween. One of the one or more compliant elements can be disposed in abutting engagement with the second surface of the base member and permanently attached thereto such that a substantially fluid-tight connection is formed between the base member and the one of the one or more compliant elements. The end structure can be supported on the compliant support structure in longitudinally-spaced relation to the base member. The end structure can include an end structure wall extending transverse to the longitudinal axis and dimensioned for securement to an associated flexible spring member.

Another example of end member assembly in accordance with the subject matter of the present disclosure can have a longitudinal axis and can be dimensioned for use in forming an associated gas spring assembly. The end member assembly can include a compliant support structure that can include a base member with a first surface dimensioned for abutting engagement with an associated structure component and a second surface facing opposite the first surface. The second surface can be approximately planar and can extend transverse to the longitudinal axis. A compliant mount assembly can be permanently attached to the base member. The compliant mount assembly can include at least two rigid elements, a base compliant element and at least two upper compliant elements. The base compliant element can be permanently attached to the base member. A first one of the at least two rigid elements can be disposed along and permanently attached to the base compliant element opposite the base member. A first one of the at least two upper compliant elements can be disposed along and permanently attached to the first one of the at least two rigid elements opposite the base compliant element. A second one of the at least two rigid elements can be disposed along and permanently attached to the first one of the at least two upper compliant elements opposite the first one of the at least two rigid elements. A second one of the at least two upper compliant elements disposed along and permanently attached to the second one of the at least two rigid elements opposite the first one of the at least two upper compliant elements. The at least two rigid elements, the base compliant element and the at least two upper compliant elements can at least partially form a substantially fluid-tight chamber with the base member. The base compliant member can have a base member spring rate and the at least two upper compliant elements be substantially identical and have a upper member spring rate that is different than the base member spring rate. An end structure can be supported on the compliant support structure in longitudinally-spaced relation to the base member. The end structure can include an end structure wall extending transverse to the longitudinal axis and dimensioned for securement to an associated flexible spring member.

One example of a gas spring assembly in accordance with the subject matter of the present disclosure can include a flexible spring member having a longitudinal axis. The flexible spring member can include a flexible wall that can extend peripherally about the longitudinal axis and longitudinally between opposing first and second ends to at least partially define a spring chamber. An end member can be secured across the first end of the flexible spring member such that a substantially fluid-tight seal is formed therebetween. An end member assembly according to either of the two foregoing paragraphs can be secured across the second end of the flexible spring member such that a substantially fluid-tight seal is formed therebetween.

One example of a suspension system in accordance with the subject matter of the present disclosure can include a pressurized gas system including a pressurized gas source and a control device in fluid communication with the pressurized gas source. At least one gas spring assembly in accordance with the foregoing paragraph can be disposed in fluid communication with the pressurized gas source with the control device disposed in fluid communication therebetween.

### BRIEF DESCRIPTION OF THE DRAWINGS

FIG. 1 is a schematic representation of one example of a rail vehicle including a suspension system in accordance with the subject matter of the present disclosure.

FIG. 2 is a schematic representation of one example of a pneumatic gas system operatively associated with the suspension system in FIG. 1.

FIG. 3 is a side elevation view of one example of a gas spring assembly including one example of an end member assembly in accordance with the subject matter of the present disclosure.

FIG. 4 is a cross-sectional side view of the gas spring assembly in FIG. 3 taken from along line 4-4 therein and shown in a first condition of use in which the gas spring assembly is fully pressurized and supporting an associated sprung mass.

FIG. 5 is an enlarged view of the portion of the gas spring assembly that is identified as Detail 5 in FIG. 4.

FIG. 6 is a cross-sectional side view of the gas spring assembly in FIGS. 3-5 shown in a second condition of use in which the gas spring assembly is unpressurized or under-pressurized and supporting the associated sprung mass.

### DETAILED DESCRIPTION

Turning now to the drawings, it is to be understood that the showings are for purposes of illustrating examples of the subject matter of the present disclosure and are not intended to be limiting. Additionally, it will be appreciated that the drawings are not to scale and that portions of certain features and/or elements may be exaggerated for purposes of clarity and/or ease of understanding.

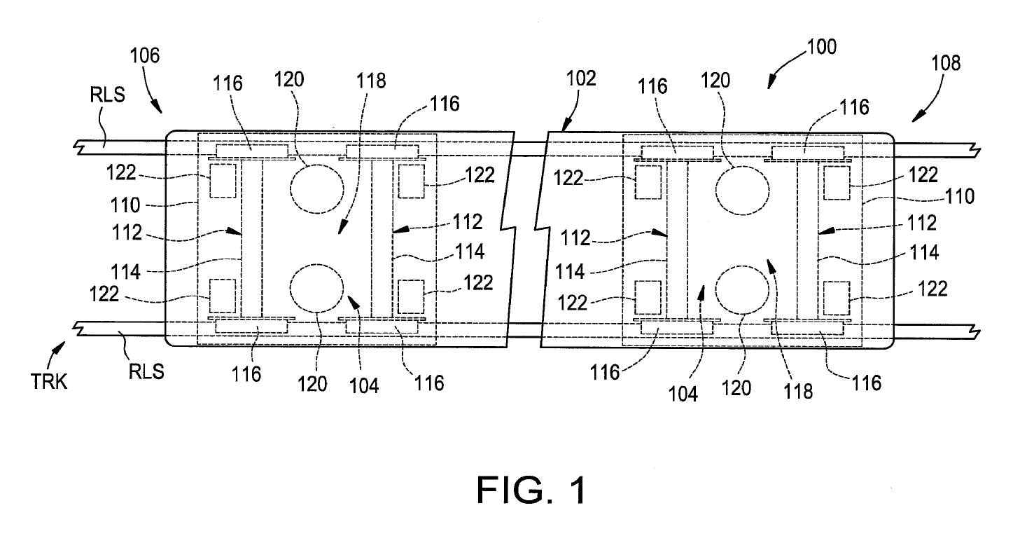

FIG. 1 illustrates one example of a vehicle including a suspension system in accordance with the subject matter of the present disclosure, such as a rail vehicle 100 that is adapted for movement or otherwise displaceable along a track TRK that is at least partially formed by rails RLS of an indefinite length. It will be appreciated that the subject matter of the present disclosure is broadly applicable for use in a wide variety of applications, and that rail vehicle 100 merely represents one example of a suitable application. Rail vehicle 100 is shown being representative of rolling stock (e.g., a railcar) rather than an engine or traction-drive vehicle. However, this representative use is merely exemplary and not intended to be limiting.

Rail vehicle 100 includes a vehicle body 102 supported on one or more frame and wheel assemblies 104, two of which are shown in FIG. 1. In some cases, frame and wheel assemblies 104 may be referred to in the art as “trucks,” “rail bogies” or simply “bogies,” and such terms may be used herein in an interchangeable manner. Bogies 104 are shown as being disposed toward opposing ends 106 and 108 of rail vehicle 100.

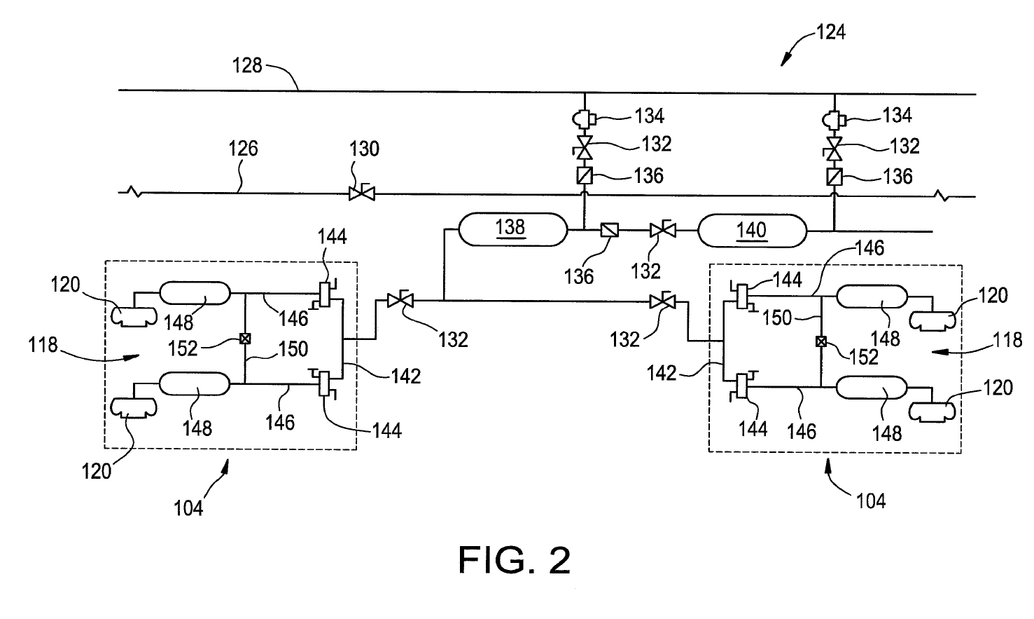

Bogies 104 are shown in FIG. 1 as including a frame 110 as well as one or more wheel sets 112 that are typically formed by an axle 114 and a pair of spaced-apart wheels 116. Normally, bogies 104 include at least two wheel sets, such as is shown in FIG. 1, for example, that are operatively connected to the frame in manner suitable to permit the wheels to roll along rails RLS of track TRK. In many cases, a primary suspension arrangement (not shown) is operatively connected between the wheels sets and the frame to permit relative movement therebetween. Bogies 104 are also shown as including a secondary suspension system 118 that includes at least one gas spring assembly. In the exemplary arrangement shown in FIGS. 1 and 2, bogies 104 include two gas spring assemblies 120 that are operatively disposed between frame 110 and vehicle body 102 to permit relative movement therebetween.

Rail vehicles, such as rail vehicle 100, for example, typically include a braking system with one or more brakes operatively associated with each wheel set. In the exemplary arrangement in FIG. 1, two brakes 122 are shown as being operatively associated with each of wheel sets 112 with one brake disposed adjacent each of wheels 116. It will be appreciated, however, that other arrangements could alternately be used.

Additionally, rail vehicles, such as rail vehicle 100, for example, typically include at least one pneumatic system that is operatively associated therewith. In many cases, components of the one or more pneumatic systems can be distributed along the length of a train that is formed from a plurality of rail vehicles, such as one or more traction-drive engines and one or more rolling stock vehicles, for example. In such cases, each individual rail vehicle will include one or more portions of the pneumatic system. Usually, these one or more portions are serially connected together to form an overall pneumatic system of a train.

Typical pneumatic systems include two or more separately controllable portions, such as a pneumatic braking system that is operatively associated with the vehicle brakes (e.g., brakes 122) and a pneumatic supply system that is operatively associated with the other pneumatically-actuated devices of the rail vehicle, such as the secondary suspension system, for example. As such, rail vehicles typically include a dedicated conduit for each of these two systems. Such conduits normally extend lengthwise along the vehicle body and are often individually referred to as a brake pipe and a supply pipe.

FIG. 2 illustrates one example of a pneumatic system 124 that is operatively associated with rail vehicle 100 and includes a braking system (not numbered) with a brake pipe 126 in fluid communication with at least brakes 122 (FIG. 1) and a pneumatic supply system (not numbered) with a supply pipe 128 in fluid communication with at least gas spring assemblies 120 of secondary suspension system 118. It will be recognized and appreciated that pneumatic system 124 will include a wide variety of other components and devices. For example, the braking system can include one or more isolation valves 130 that can be fluidically connected along brake pipe 126. As other examples, the pneumatic supply system can include one or more isolation valves 132, one or more filters 134 and/or one or more non-return valves 136 (which may be alternately referred to as one-way or check valves). The pneumatic supply system can also include one or more reservoirs or other pressurized gas storage devices. In the arrangement shown in FIG. 2, for example, the pneumatic supply system includes a reservoir 138 that is operative to store a quantity of pressurized gas for use in supplying gas spring assemblies 120 of the secondary suspension system, and a reservoir 140 that can be operative to store a quantity of pressurized gas for use as an auxiliary reservoir of the braking system.

Generally, certain components of the braking system, such as brakes 122, for example, as well as certain components of the pneumatic supply system are supported on or otherwise operatively associated with one of bogies 104 of rail vehicle 100. For example, supply lines 142 can fluidically interconnect bogies 104 with the pneumatic supply system. Supply lines 142 are shown as being fluidically connected with one or more leveling valves 144 that are operatively connected with gas spring assemblies 120, such as by way of gas lines 146, and are selectively operable to transfer pressurized gas into and out of the gas spring assemblies. In some cases, a pressurized gas storage device or reservoir 148 can, optionally, be fluidically connected along gas line 146 between leveling valve 144 and gas spring assembly 120. Additionally, a cross-flow line 150 can, optionally, be connected in fluid communication between two or more of gas lines 146. In some cases, a control valve 152, such as a duplex check valve, for example, can be fluidically connected along cross-flow line 150, such as is shown in FIG. 2, for example.

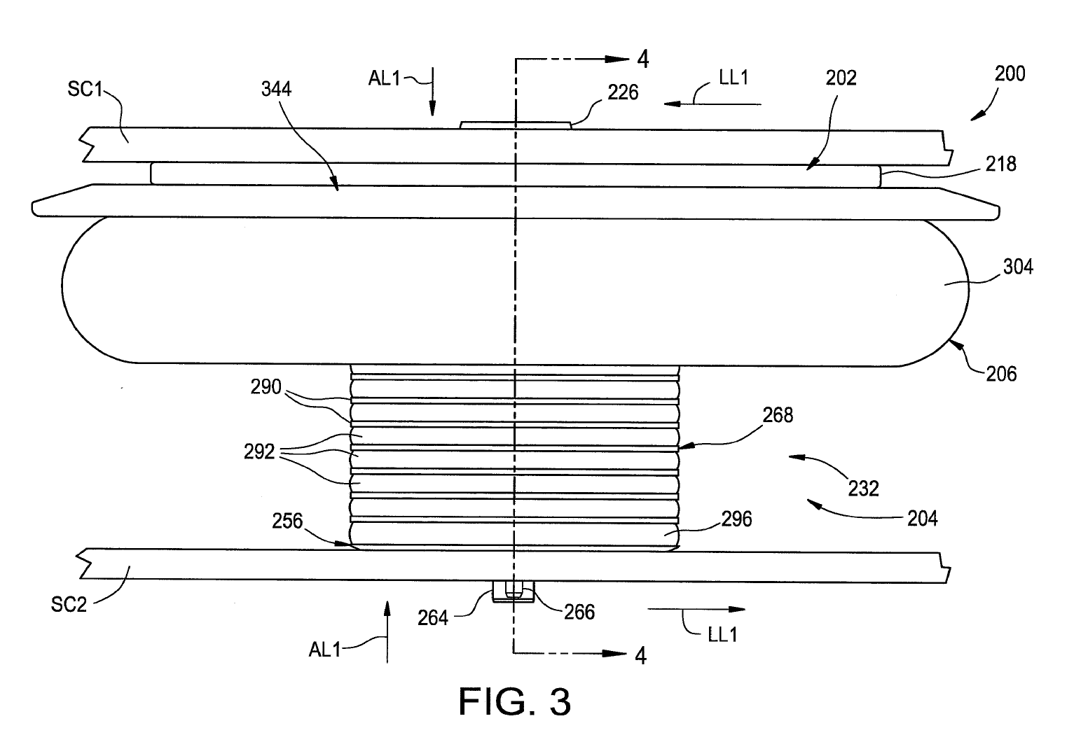

One example of a gas spring assembly in accordance with the subject matter of the present disclosure, such as may be suitable for use as one or more of gas spring assemblies 120 in FIGS. 1 and 2, for example, is shown as gas spring assembly 200 in FIGS. 3-6. The gas spring assembly has a longitudinal axis AX and includes an end member (which may alternately referred to herein as an end member assembly) 202, an end member (which may, alternately, be referred to herein as an end member assembly) 204 spaced longitudinally from end member 202 and a flexible spring member or sleeve 206 that extends peripherally about the longitudinal axis and is secured between the end members to at least partially define a spring chamber 208.

Gas spring assembly 200 can be disposed between associated sprung and unsprung masses of an associated vehicle in any suitable manner. For example, one end member can be operatively connected to an associated sprung mass with the other end member disposed toward and operatively connected to an associated unsprung mass. In the arrangement shown in FIGS. 3-6, for example, end member 202 is secured on or along a structural component SC1, such as associated vehicle body 102 in FIG. 1, for example, and can be secured thereon in any suitable manner. As another example, end member 204 is secured on or along a structural component SC2, such as associated rail bogie 104 in FIG. 1, for example, and can be secured thereon in any suitable manner.

In the exemplary arrangement in FIGS. 3-6, end member 202 is shown as taking the form of a top plate having a plate wall 210 that has opposing surfaces 212 and 214 such that a plate height (not identified) is at least partially defined therebetween. Plate wall 210 is shown as being generally planar and extending outwardly to an outer periphery 216. In some cases, plate wall 210 can have a generally circular shape such that an outer peripheral surface 218 can have a generally cylindrical shape. A passage surface 220 can at least partially define a gas transfer passage 222 extending through the end member such that pressurized gas can be transferred into and out of spring chamber 208, such as by way of pneumatic system 124 (FIG. 2) for example. In some cases, the end member can include a projection or boss 224 that extends from along plate wall 210 in a longitudinal direction. In the exemplary arrangement shown in FIGS. 3, 4 and 6, projection 224 extends in an axially-outward direction away from spring chamber 208.

As mentioned above, one or more securement devices can be used to secure or otherwise interconnect the end members of the gas spring assembly with corresponding structural components. For example, one or more threaded fasteners and/or other features could operatively secure the end member to the associated structural component. Additionally, or in the alternative, projection 224 can include an outer surface 226 that is dimensioned for receipt within a passage or mounting hole MHL that extends into or through structural component SC1. Additionally, one or more sealing elements 228 can, optionally, be included that are disposed between or otherwise at least partially form a substantially fluid-tight connection between the end member and the structural component, such as between projection 224 and the inside surface (not numbered) of structural component SC1 through which mounting hole MHL extends, for example. In some cases, structural component SC1 can, optionally, at least partially define an external reservoir suitable for storing a quantity of pressurized gas.

End member assembly 204 is shown in FIGS. 3-6 as being one example of an end member assembly in accordance with the subject matter of the present disclosure. End member assembly 204 includes an end structure 230 and a compliant support structure 232 that are operatively connected to one another. End structure 230 can include an end structure wall 234 that has opposing surfaces 236 and 238 such that a height (not identified) is at least partially defined therebetween. End structure wall 234 is shown as being generally planar and extending outwardly to an outer periphery 240. In some cases, end structure 230 can have a generally circular shape such that an outer peripheral surface 242 can have a generally cylindrical shape. Additionally, in some cases, end structure 230 can, optionally, include an inner surface 244 that at least partially defines a passage 246 extending through end structure wall 234 and into fluid communication with spring chamber 208. End structure 230 can also, optionally, include an endless annular recess or groove 248 that extends axially inward into the end structure wall, such as from along surface 236 thereof. It will be appreciated that such a groove, if provided, can be of any suitable size, shape, configuration and/or arrangement. For example, groove 248 is shown as being at least partially defined by a bottom surface 250, an inner side surface 252 and an outer side surface 254. In a preferred arrangement, groove 248 can be dimensioned to at least partially receive a portion of flexible spring member 206 and one or more retaining elements, such as may be used to secure the flexible spring member on or along the end structure, for example.

It will be appreciated that compliant support structure 232 can include any suitable construction, configuration and/or arrangement of features and components, and that end structure 230 can be supported on or along compliant support structure 232 in any suitable manner. For example, compliant support structure 232 is shown in FIGS. 3-6 as including a base member 256 that includes a base wall 258 with opposing inner and outer surfaces 260 and 262. In a preferred arrangement, surfaces 260 and 262 of base wall 258 can be approximately planar and disposed in an offset arrangement with one another in an axial direction. Additionally, as mentioned above, one or more securement devices can be used to secure or otherwise interconnect the end members of the gas spring assembly with corresponding structural components. Base wall 258 can include at least one securement feature suitable for operatively engaging the base wall with an associated structural component. For example, one or more threaded fasteners and/or other features could operatively secure the end member to the associated structural component.

Additionally, or in the alternative, the one or more securement features can include a projection or post 264 extending axially outward from outer surface 262. Post 264 can be dimensioned for receipt within a passage or mounting hole MHL that extends into or through structural component SC2. In some cases, the one or more securement features can also include a projection or post 266 that extends axially outward from outer surface 262 in offset relation to post 264 such that at least a portion of posts 264 and 266 are co-extensive. If provided, post 266 can also be dimensioned for receipt within a passage or mounting hole MHL extending into or through structural component SC2. In such an arrangement, the offset position of post 266 relative to post 264 and axis AX can substantially inhibit rotation of end member assembly 204 (and gas spring assembly 200) about axis AX. It will be appreciated, however, that other arrangements could alternately be used. As one example, one or more threaded fasteners and corresponding threaded features could be used to operatively secure end member assembly 204 on or along the associated structural component.

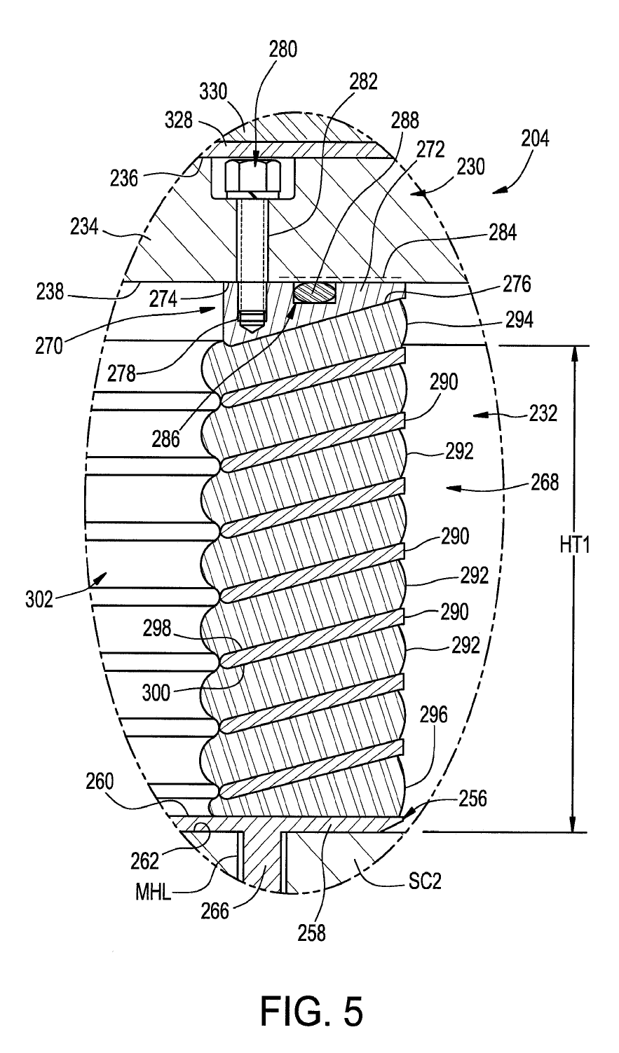

End structure 230 can be supported on base member 256 by a compliant mount assembly 268 that together with base member 256 at least partially forms compliant support structure 232. In some cases, compliant support structure 232 can include a mounting member 270 supported on compliant mount assembly 268 in spaced relation to base member 256. In such case, compliant mount assembly 268 can extend between and operatively connect the mounting and base members such that a non-zero distance or height is formed therebetween, such as is represented in FIG. 5 by reference dimension HT1, for example. If included, mounting member 270 can include a mounting member wall 272 with a surface 274 facing away from base member 256 and a surface 276 facing opposite surface 274 and generally toward the base member. In a preferred arrangement, surface 274 can be approximately planar or otherwise configured for abuttingly engaging surface 238 of end structure 230. Additionally, in a preferred arrangement, surface 276 can have a non-planar cross-sectional profile or shape, such as an approximately frustoconical configuration, for example.

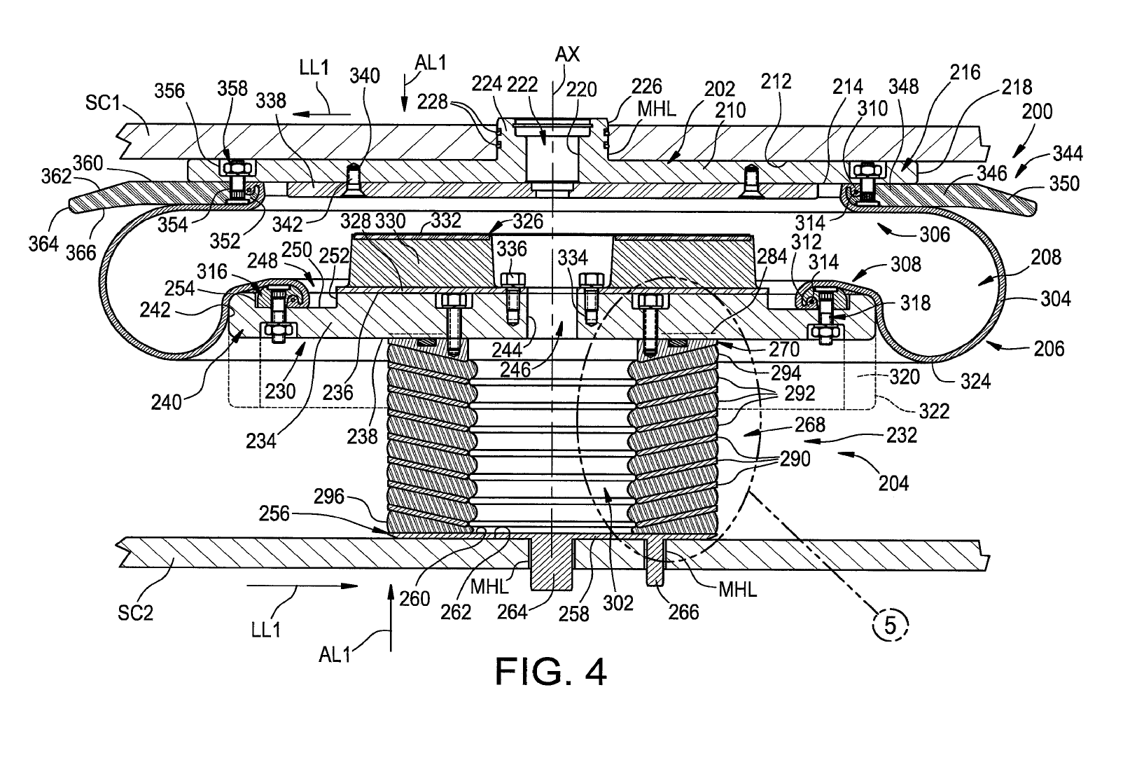

It will be appreciated that end structure 230 can be supported on or along compliant support structure 232, such as on or along mounting member 270, for example, in any suitable manner. Additionally, it will be appreciated that, if provided, mounting member 270 can abuttingly engage or otherwise operatively support end structure 230 in any suitable manner. As one example, the end structure can be secured on or along the compliant support structure by way of a flowed-material joint (not shown). As another example, one or more securement features and/or devices can be provided on or along the mounting member in a manner suitable for operatively attaching the end structure and the compliant support structure to one another. In the arrangement shown in FIGS. 4-6, one or more securement features 278 (e.g., through passages accessible from along both of surfaces 274 and 276 or blind holes accessible from along only one of the surfaces) can extend into mounting member wall 272, such as from along surface 274, for example. In some cases, the one or more securement features can include one or more helical threads, and can be dimensioned to receivingly engage corresponding securement devices 280, such as threaded fasteners, for example, that extend into and/or at least partially through holes or passages 282 in end structure wall 234 and into engagement with securement features 278.

In some cases, end structure 230 and mounting member 270 can be operatively connected with one another such that a substantially fluid-tight interface is formed therebetween. It will be appreciated that such a substantially fluid-tight interface can be formed in any suitable manner. As one example, a flowed-material joint could be included, such as between surface 238 of end structure 230 and surface 274 of mounting member 270, such as is represented in FIGS. 4-6 by dashed line 284, for example. Additionally, or in the alternative, one or more sealing elements could be operatively disposed between the end structure and the mounting member. It will be appreciated that any suitable arrangement and/or configuration of features and/or elements could be used. For example, an endless annular groove 286 can extend axially into either or both of the end structure wall and/or the mounting member wall. In such case, groove 286 can be dimensioned to at least partially receive and retain a sealing element 288 operative to at least partially form a substantially fluid-tight seal between the end structure and the mounting member. It will be appreciated, however, that the arrangement shown in merely exemplary and that other configurations and/or arrangements could alternately be used.

A compliant support structure in accordance with the subject matter of the present disclosure can provide improved (i.e., reduced) spring rates in both the lateral and vertical directions in comparison with conventional, known constructions. In particular, in a preferred embodiment, a compliant support structure in accordance with the subject matter of the present disclosure can include a compliant mount assembly with a base compliant element assembled together with a plurality of upper compliant elements that are substantially identical to one another. In such a construction, the base compliant element has a base element configuration and a base element spring (in at least one of the lateral and vertical directions), and the plurality of upper compliant elements have an upper element configuration and an upper element spring rate (in at least one of the lateral and vertical directions) that differ in comparison with the corresponding configuration and spring rate of the base compliant element. It will be appreciated that any suitable construction, configuration and/or arrangement of components in accordance with the subject matter of the present disclosure could be used. Thus, it is to be recognized and appreciated that the embodiments shown and described herein are merely exemplary and not intended to be limiting.

Additionally, a compliant mount assembly in accordance with the subject matter of the present disclosure will include at least two rigid elements and at least three comparatively compliant elements that are stacked, sandwiched or otherwise disposed in serial relation to one another. In a preferred arrangement, the two or more rigid elements can be formed from metal material (e.g., steel and/or aluminum), rigid thermoplastic material (e.g., polyamide) or any combination thereof. Additionally, in a preferred arrangement, the three or more compliant elements can be formed from an elastomeric material (e.g., natural rubber, synthetic rubber and/or thermoplastic elastomer). Additionally, in a preferred construction, the two or more rigid elements and the three or more compliant elements are permanently attached to one another (i.e., inseparable without damage, destruction or material alteration of at least one of the component parts).

In the exemplary arrangement shown in FIGS. 3-6, compliant mount assembly 268 includes a plurality of rigid elements 290 as well as a plurality of compliant elements. In particular, compliant mount assembly 268 is shown as including a plurality of compliant elements 292, which may alternately be referred to herein as upper or intermediate compliant elements. Additionally, the compliant mount assembly can, optionally, include a compliant element 294, which may alternately be referred to herein as an upper or intermediate compliant element. In some cases, compliant elements 292 and 294 can be substantially identical to one another in construction and spring rate (in at least one of the lateral and vertical directions). In a preferred arrangement, compliant mount assembly 268 also includes a compliant element 296, which may alternately be referred to herein as a base compliant element.

Rigid elements 290 are identified as having opposing surfaces 298 and 300. In the configuration shown, rigid elements 290 are formed from thin-walled material and have a frustoconical shape with a hollow interior. Compliant elements 292 can be attached to surfaces 298 and 300 of adjacent ones of rigid elements 290. If provided, compliant element 294 can be attached between surfaces 276 of mounting member 270 and surface 298 of an adjacent one of rigid elements 290. Compliant element 296 can be attached between inner surface 260 of base member 256 and surface 300 of an adjacent one of rigid elements 290. As indicated above, in a preferred construction, the one or more rigid elements and the one or more compliant elements are permanently attached to one another (i.e., inseparable without damage, destruction or material alteration of at least one of the component parts).

As discussed above, it will be appreciated that the rigid and compliant elements as well as the base member and the mounting member, if provided, can be attached to one another in any suitable manner. In a preferred arrangement, permanent and substantially fluid-tight joints or connections are formed between compliant elements 292, 294 and 296 and respective ones of adjacent rigid elements 290, base member 256 and mounting member 270. In some cases, such substantially fluid-tight joints or connections can be formed by way of one or more processes and/or can include the use of one or more treatments and/or materials. Exemplary processes can include molding, adhering, curing and/or vulcanizing. In this manner, an end member chamber 302 can be formed within end member 204 that is substantially fluid-tight and can retain a quantity of pressurized gas at a desired pressure for an extended period of time, such as a period of hours, days, weeks or months, for example. In a preferred arrangement, passage 246 that extends through end structure wall 234 is also disposed in fluid communication with end member chamber 302. In such case, pressurized gas can be transferred into, out of and/or between end member chamber 302 and spring chamber 208 through passage 246 in the end structure. In some cases, passage 246 may be of sufficient size such that chambers 208 and 302 function as a single volume of pressurized gas.

In a preferred construction of a compliant mount assembly in accordance with the subject matter of the present disclosure, such as compliant mount assembly 268, for example, the configuration and/or construction of the base compliant element will differ from configuration and/or construction of the upper and/or intermediate compliant elements. Additionally, in a preferred construction, the axial and lateral spring rates of the base compliant element of a compliant mount assembly in accordance with the subject matter of the present disclosure will differ from the axial and lateral spring rates of the corresponding upper and/or intermediate compliant elements. In some cases, the axial and lateral spring rates of the base compliant element can differ by at least ten (10) percent from the corresponding axial and lateral spring rates of the upper and/or intermediate compliant elements.

In such cases, it will be appreciated that the overall axial (or vertical) spring rate of the compliant mount assembly can be characterized by:

$$n \cdot \frac{1}{{k}_{A 1}} + \frac{1}{{k}_{A 2}} = \frac{1}{{k}_{AT}}$$

where, the variable “n” refers to the number of upper and/or intermediate compliant elements included in the compliant mount assembly, the variable “k_{A1}” refers to the axial (or vertical) spring rate of the upper and/or intermediate compliant elements, the variable “k_{A2}” refers to the axial (or vertical) spring rate of the base compliant element, and the variable “k_{AT}” refers to the overall or total axial (or vertical) spring rate of the compliant mount assembly.

Additionally, it will be appreciated that the overall lateral (or horizontal) spring rate of the compliant mount assembly can be characterized by:

$$n \cdot \frac{1}{{k}_{L 1}} + \frac{1}{{k}_{L 2}} = \frac{1}{{k}_{LT}}$$

where, the variable “n” refers to the number of upper and/or intermediate compliant elements included in the compliant mount assembly, the variable “k_{L1}” refers to the lateral (or horizontal) spring rate of the upper and/or intermediate compliant elements, the variable “k_{L2}” refers to the lateral (or horizontal) spring rate of the base compliant element, and the variable “k_{LT}” refers to the overall or total lateral (or horizontal) spring rate of the compliant mount assembly.

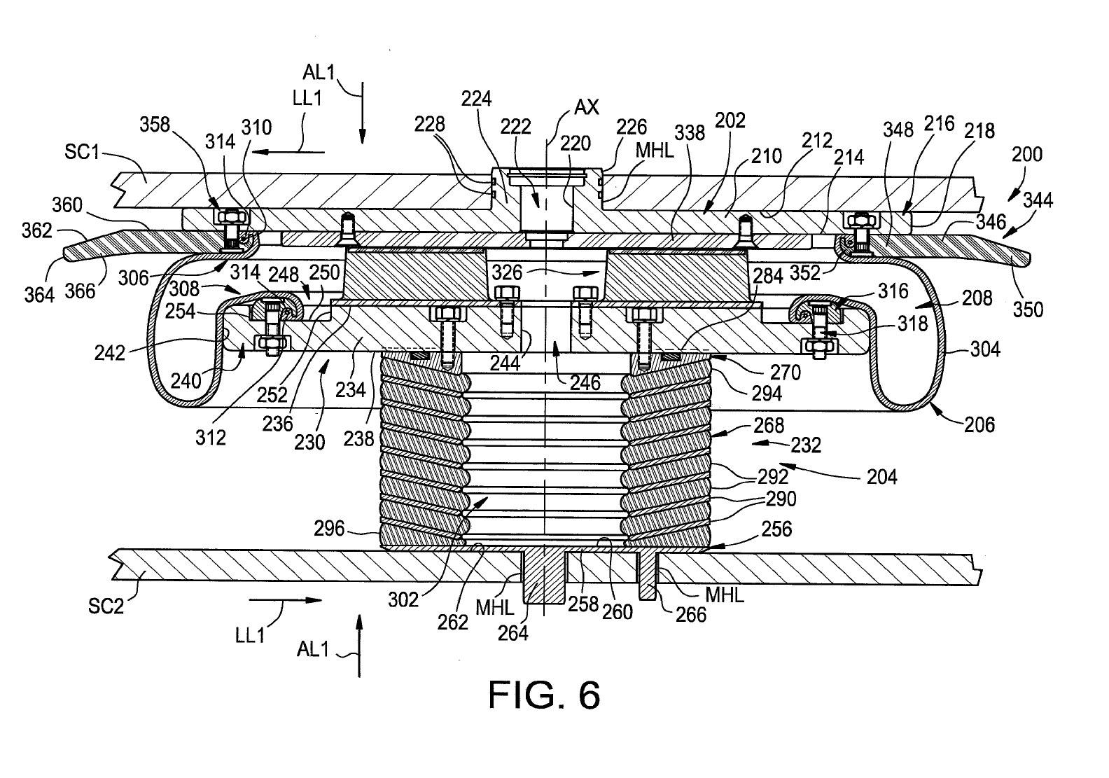

Flexible spring member 206 can be of any suitable size, shape, construction and/or configuration. As one example, flexible spring member 206 can include a flexible wall 304 that is at least partially formed from one or more layers or plies (not identified) of elastomeric material (e.g., natural rubber, synthetic rubber and/or thermoplastic elastomer) and can optionally include one or more plies or layers of filament reinforcing material (not shown). Flexible wall 304 is shown extending in a longitudinal direction between opposing ends 306 and 308. In some cases, flexible wall 304 can, optionally, include a mounting bead dispose along either one or both of ends 306 and 308. In the arrangement shown in FIGS. 4 and 6, mounting beads 310 and 312 are shown as being respectively disposed along ends 306 and 308. In some cases, the mounting beads can, optionally, include a reinforcing element, such as an endless, annular bead core 314, for example.

It will be appreciated, that the ends of flexible spring member 206 can be secured on, along or otherwise interconnected between end members 202 and 204 in any suitable manner. As one example, gas spring assembly 200 can include one or more bead retaining elements that engage at least a portion of the flexible spring member and maintain the flexible spring member in substantially fluid-tight engagement with the corresponding end member assembly (e.g., end member assembly 202 and/or 204). In the arrangement shown in FIGS. 4-6, for example, end 308 of flexible wall 304 is disposed in abutting engagement with bottom surface 250 of groove 248 in end structure 230. A bead retaining element 316, such as in the form of an endless, annular ring, for example, captures at least a portion of mounting bead 312 and is shown as being secured on or along end structure 230 by way of a plurality of securement devices 318, such as, for example, threaded fastener (not numbered) and threaded nut (not numbered) combinations that extend through at least approximately aligned holes or slots (not numbered) in the bead retaining element and/or the end structure.

Typically, at least a portion of flexible spring member 206 will extend radially outward beyond outer periphery 240 of end structure 230. In some cases, such as is shown in FIG. 4, for example, end member 204 can include an outer support wall 320 that can, optionally, extend peripherally around or otherwise along end structure 230, such as from along the end structure and in a direction toward base member 256. In such cases, outer support wall 320 can extend axially along (i.e., be axially co-extensive with) at least a portion of compliant support structure 232 and, in a preferred arrangement, can be disposed radially outward from compliant mount assembly 268 of the compliant support structure. Flexible spring member 206 can extend along an outer surface 322 of outer support wall 320 such that a rolling lobe 324 can be formed along the flexible spring member. Outer surface 322 is shown in FIG. 4 as having a generally cylindrical shape, and rolling lobe 324 can be displaceable along the outer surface as the gas spring assembly is axially displaced between extended and compressed conditions, such as may occur during dynamic use in operation. It will be appreciated that other shapes and/or configurations of outer support wall 322 and/or outer surface 324 can alternately be used, such as may be useful to provide desired performance characteristics, for example.

As is well known in the art, it is generally desirable to avoid or at least minimize contact between end members of a gas spring assembly, such as may occur due to variations in load conditions and/or upon deflation of the gas spring assembly, for example. Additionally, or in the alternative, it may be desirable to support a sprung mass (e.g., vehicle body 102) at a predetermined height or distance (or within a predetermined range of heights or distances) relative to the unsprung mass (e.g., bogies 104) during uninflated, underinflated or other such condition of the gas spring assembly. As such, gas spring assembly 200 is shown in FIGS. 4-6 as including a jounce bumper 326 that is disposed within spring chamber 208 and supported on end member 204. As identified in FIGS. 4-6, jounce bumper 326 is shown as including a mounting plate 328 that is disposed in abutting engagement with end member 204, a bumper body 330 supported on the mounting plate, and a wear plate 332 that is supported on or along bumper body 330, such as, for example, by being at least partially embedded within the bumper body.

It will be appreciated that jounce bumper 326 can be secured on or along an end member in any suitable manner. As identified in FIGS. 4-6, for example, end structure wall 234 of end structure 230 is shown as including one or more securement features 334, such as may take the form of a plurality of threaded holes, for example. In such case, a corresponding number of one or more securement devices 336, such as one or more threaded fasteners, for example, can extend through one of a corresponding number of holes, openings or other features of the jounce bumper or a component thereof (e.g., mounting plate 328) to secure the jounce bumper on or along the end member.

Gas spring assembly 200 can also, optionally, include a complimentary component that may be dimensioned to or otherwise suitable for abuttingly engaging the jounce bumper or a component thereof (e.g., wear plate 332). In the arrangement shown in FIGS. 4-6, gas spring assembly 200 includes a bearing plate 338 that is disposed in abutting engagement along surface 214 of plate wall 210 and is secured on or along end member 202. It will be appreciated that the bearing plate can be attached to the end member in any suitable manner. For example, plate wall 210 of end member 202 can include one or more securement features 340, such as threaded holes, for example, that as may be suitable for receiving a complimentary securement device 342, such as a threaded fastener, for example, to secure the bearing plate on or along the end member.

As discussed above, it will be appreciated, that the ends of flexible spring member 206 can be secured on, along or otherwise interconnected between end members 202 and 204 in any suitable manner. As mentioned above, for example, gas spring assembly 200 can include one or more bead retaining elements that engage at least a portion of the flexible spring member and maintain the flexible spring member in substantially fluid-tight engagement with the corresponding end member assembly (e.g., end member assembly 202 and/or 204). In some cases, a bead retaining element, such as bead retaining element 316, for example, could be used. Alternately, one or more bead retaining features can be formed on or along another component of the gas spring assembly. For example, in the arrangement shown in FIGS. 4 and 6, gas spring assembly 200 includes a lateral support element 344 that is configured to engage a portion of flexible spring member 206 during lateral movement of end member assemblies 202 and/or 204 relative to one another. Additionally, lateral support element 344 can, optionally, be adapted or otherwise configured to secured or otherwise support an end of a flexible wall, such as end 306, for example, on or along an end member, such as end member 202, for example.

As identified in FIGS. 4 and 6, lateral support element 344 includes an element wall 346 in the form of an endless, annular ring that extends radially between an inward or mounting portion 348 and an outward or support portion 350. As illustrated in the cross-sectional profile shown in FIGS. 4 and 6, element wall 346 includes a bead-retaining wall portion 352 that extends in a radially-inward direction from along mounting portion 348. In some cases, bead-retaining wall portion 352 can have a somewhat hook-shaped cross-sectional profile and can, in some cases, form an innermost radial extent of the lateral support element. In a preferred arrangement, bead-retaining wall portion 352 can retain end 306 of flexible wall 304 in abutting engagement with surface 214 of plate wall 210.

Additionally, it will be appreciated that lateral support element 344 can be secured on or along end member 202 in any suitable manner. As one example, lateral support element 340 can include a plurality of holes or openings 354 extending therethrough that are disposed in spaced relation to one another about element wall 346, such as in peripherally-spaced relation to one another along mounting portion 348 thereof, for example. In such case, plate wall 210 of end member 202 can include a corresponding plurality of holes or openings 356 that, together with holes 354, are dimensioned to receive one of a plurality of securement devices 358, such as threaded fastener and threaded nut assemblies, for example. In this manner, lateral support element 344 can be secured on end member 202, and flexible spring member 206 can be operatively secured to the end member such that a substantially fluid-tight seal can be formed therebetween.

With further reference to FIGS. 4 and 6, element wall 346 of lateral support element 344 is shown as including a mounting surface 360 that is dimensioned or otherwise configured to abuttingly engage an associated component or structural feature, such as plate wall 210 of end member 202, for example. Element wall 346 also includes an outer surface 362 along support portion 350 that can have any suitable shape and/or configuration, such as a frustoconical shape, for example. Element wall 346 can include an outer peripheral wall portion 364 that, in some cases, can at least partially define an outermost peripheral extent of lateral support element 344. The element wall (e.g., element wall 346) of a lateral support element, such as lateral support element 310, for example, can further include a support surface having a cross-sectional profile suitable for operatively engaging and at least partially supporting, either directly or indirectly, the flexible wall of the gas spring assembly during lateral (i.e., transverse) movement of the end members relative to one another.

As identified in FIGS. 4 and 6, element wall 346 of lateral support element 344 can include a support surface 366 that is shown as facing in a direction generally opposite mounting surface 360 and/or outer surface 362. In a preferred arrangement, element wall 346 is positioned such that at least a portion of support surface 366 can abuttingly engage a portion of flexible spring member 206 during lateral (i.e., transverse) movement of end member 202 relative to end member 204. It will be appreciated that lateral support elements having support surfaces with cross-sectional profiles of a variety of shapes, sizes and configurations have been developed and are commonly used, such as may be suitable for contributing to certain lateral performance characteristics of a gas spring assembly, for example. As such, it will be appreciated that a support surface having a cross-sectional profile of any suitable size, shape and/or configuration could be used.

With further reference to the performance of a gas spring assembly in accordance with the subject matter of the present disclosure (e.g., gas spring assemblies 120 and/or 200), it will be appreciated that an end member assembly in accordance with the subject matter of the present disclosure, such as end member 204, for example, can contribute to the overall performance characteristics of such a gas spring assembly. Additionally, it will be recognized and appreciated that the contribution to the overall performance characteristics made by the end member assembly will be a function, at least in part, of the performance characteristics of the rigid and compliant elements from which the end member assembly is formed. That is, it will be recognized that the individual performance characteristics of the plurality of rigid and compliant elements of the end member will combine to at least partially establish the overall performance characteristics of the end member assembly, such as overall axial and lateral spring rates and corresponding axial and lateral deflections, for example. Thus, it will be appreciated that rigid and compliant elements having any combination of performance characteristics can be used.

As examples, in some cases, the rigid elements can be substantially identical to one another. In other cases, rigid elements having two or more different configurations and/or performance characteristics could be used. As additional examples, or alternate examples, the compliant elements can, in in some cases, be substantially identical to one another. In other cases, compliant elements having two or more different configurations, constructions and/or performance characteristics could be used. As such, it will be recognized and appreciated that different constructions, configurations and/or arrangements of rigid and compliant elements can be used to provide desired performance characteristics of the end member assembly (e.g., end member assembly 204) and corresponding gas spring assembly (e.g., gas spring assemblies 120 and/or 200).

For example, gas spring assembly 200 is shown in FIGS. 3-5 in a first condition of use in which the gas spring assembly contains a desired quantity of pressurized gas, which represents a fully inflated condition. Additionally, gas spring assembly 200 is shown in FIGS. 3-5 as being in use under load, such as is represented by arrows AL1. Under such conditions of use, the axial deflection of gas spring assembly 200 will be influenced by factors such as the construction and configuration of the flexible wall of the gas spring assembly, the effective diameter of the gas spring assembly and the quantity and pressure of gas within the gas spring assembly, which contribute to the axial spring rate of the gas spring assembly. Additionally, under such conditions of use, any lateral deflection of gas spring assembly 200 will be influenced by the configuration and/or construction of one or more of the end members and/or any lateral support element (e.g., lateral support element 344) secured thereto that abuttingly engages the flexible wall in a fully inflated condition of the gas spring assembly.

Gas spring assembly 200 is shown in FIG. 6 as containing less than the desired quantity of pressurized gas, which represents an uninflated or under-inflated condition of the gas spring assembly. Additionally, the gas spring assembly is shown in FIG. 6 as being in use under load, such as is represented by arrows AL1. Under such conditions of use, it will be appreciated that the load will be supported by the engagement of the end members (and other internal components of the gas spring assembly) with one another, rather than by pressurized gas as in a fully inflated condition. In such cases, the axial deflection of the gas spring assembly will be influenced by the axial spring rate of the end members, such as the overall axial spring rate of end member assembly 204, for example. Additionally, under such conditions of use, it will be appreciated that lateral support elements (e.g., lateral support element 344) are substantially disengaged from the flexible wall and, as such, are largely ineffective at influencing lateral loads, such as are represented in FIG. 6 by arrows LL1. Rather, under such conditions of use, the lateral deflection of the gas spring assembly will be influenced by the overall lateral spring rate of the end members (e.g., end member assembly 204), such as may be established by the construction of compliant mount assembly 268, for example, and the interengagement between the end members and any other internal components of the gas spring assembly.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and substantially fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and substantially fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. An end member assembly having a longitudinal axis and dimensioned for use in forming an associated gas spring assembly, said end member assembly comprising:
a compliant support structure including a compliant mount assembly and a base member that is operatively connected to said compliant mount assembly, said base member including a first surface dimensioned for abutting engagement with an associated structure component and a second surface facing opposite said first surface, said second surface being approximately planar and extending transverse to said longitudinal axis, said compliant mount assembly including one or more rigid elements and one or more compliant elements that are permanently attached to one another such that a substantially fluid-tight connection is formed therebetween with one of said one or more compliant elements disposed in abutting engagement with said second surface of said base member and permanently attached thereto such that a substantially fluid-tight connection is formed between said base member and said one of said one or more compliant elements; and,
an end structure supported on said compliant support structure in longitudinally-spaced relation to said base member, said end structure including an end structure wall extending transverse to said longitudinal axis and dimensioned for securement to an associated flexible spring member.

2. An end member assembly according to claim 1, wherein said one or more rigid elements include at least two rigid elements and said one or more compliant elements include at least three compliant elements with said at least two rigid elements and said at least three compliant elements stacked in alternating serial relation to one another.

3. An end member assembly according to claim 1, wherein said one or more rigid elements include at least five rigid elements and said one or more compliant elements include at least six compliant elements with said at least five rigid elements and said at least six compliant elements stacked in alternating serial relation to one another.

4. An end member assembly according to claim 1, wherein said one or more rigid elements include at least one frustoconical surface.

5. An end member assembly according to claim 4, wherein said one or more rigid elements are formed from a thin-walled material and include inner and outer frustoconical surfaces facing in opposing directions.

6. An end member assembly according to claim 1, wherein said one or more rigid elements are formed from one of a metal material and a rigid polymeric material, and said one or more compliant elements are formed from an elastomeric material.

7. An end member assembly according to claim 1, wherein said one or more compliant elements, said one or more rigid elements and said base member together at least partially define an end member chamber within said end member assembly.

8. An end member assembly according to claim 7, wherein said end structure wall includes at least one passage extending through said end structure in fluid communication with said end member chamber.

9. An end member assembly according to claim 1, wherein said end structure is supported on said compliant support structure such that a substantially fluid-tight seal is formed therebetween.

10. An end member assembly according to claim 1, wherein said compliant mount assembly includes a mounting member disposed in spaced relation to said base member and permanently attached to one of said one or more compliant elements such that a substantially fluid-tight connection is formed therebetween.

11. An end member assembly according to claim 10, wherein said end structure is operatively engaged with said mounting member such that a substantially fluid-tight seal is formed therebetween.

12. An end member assembly according to claim 11, wherein a sealing element is sealingly disposed between said end structure and said mounting member.

13. An end member assembly according to claim 12, wherein said mounting member includes a mounting member wall with a first surface having an approximately frustoconical shape that is operatively engaged with said one of said one or more compliant elements and a second surface facing opposite said first surface, said second surface being approximately planar and extending transverse to said longitudinal axis.

14. An end member assembly according to claim 13, wherein at least one of said end structure wall and said mounting member wall includes an annular groove dimensioned to at least partially receive said sealing element.

15. An end member assembly according to claim 10, wherein a flowed-material joint extends between said end structure and said mounting member.

16. An end member assembly having a longitudinal axis and dimensioned for use in forming an associated gas spring assembly, said end member assembly comprising:
a compliant support structure including:
a base member that includes a first surface dimensioned for abutting engagement with an associated structure component and a second surface facing opposite said first surface, said second surface being approximately planar and extending transverse to said longitudinal axis;
a compliant mount assembly permanently attached to said base member, said compliant mount assembly including at least two rigid elements, a base compliant element and at least two upper compliant elements, said base compliant element permanently attached to said base member, a first one of said at least two rigid elements disposed along and permanently attached to said base compliant element opposite said base member, a first one of said at least two upper compliant elements disposed along and permanently attached to said first one of said at least two rigid elements opposite said base compliant element, a second one of said at least two rigid elements disposed along and permanently attached to said first one of said at least two upper compliant elements opposite said first one of said at least two rigid elements, and a second one of said at least two upper compliant elements disposed along and permanently attached to said second one of said at least two rigid elements opposite said first one of said at least two upper compliant elements such that said at least two rigid elements, said base compliant element and said at least two upper compliant elements at least partially form a substantially fluid-tight chamber with said base member;
said base compliant member having a base member spring rate and said at least two upper compliant elements being substantially identical and having a upper member spring rate that is different than said base member spring rate; and,
an end structure supported on said compliant support structure in longitudinally-spaced relation to said base member, said end structure including an end structure wall extending transverse to said longitudinal axis and dimensioned for securement to an associated flexible spring member.

17. An end member assembly according to any one of claim 16, wherein said compliant mount assembly includes a mounting member disposed in spaced relation to said base member and permanently attached to said second or a later one of said at least to upper compliant elements such that a substantially fluid-tight connection is formed therebetween.

18. A gas spring assembly comprising:
a flexible spring member having a longitudinal axis and including a flexible wall extending peripherally about said axis and longitudinally between opposing first and second ends to at least partially define a spring chamber;
an end member extending across said first end of said flexible spring member and secured thereto such that a substantially fluid-tight seal is formed therebetween; and,
an end member assembly according to claim 1 extending across said second end of said flexible spring member and secured thereto such that a substantially fluid-tight seal is formed therebetween.

19. A gas spring assembly according to claim 18, wherein said end structure includes a side wall portion, and said flexible wall of said flexible spring member forms a rolling lobe that is displaceable along said side wall portion as said gas spring assembly undergoes extension and compression during use.

20. A suspension system comprising:
a pressurized gas system that includes a pressurized gas source and a control device; and,
at least one gas spring assembly according to claim 18, said at least one gas spring assembly disposed in fluid communication with said pressurized gas source through said control device such that pressurized gas can be selectively transferred into and out of at least said spring chamber of said at least one gas spring assembly.
